(19) United States
(12) Patent Application Publication
(10) Pub. No.: US 2003/0036899 A1
(43) Pub. Date: Feb. 20, 2003

(54) Customizing the presentation of information to suit a user's personality type

(75) Inventors: William Ellis Leslie, Roswell, GA (US); William Philip Shaouy, Marietta, GA (US); Matthew Bunkley Trevathan, Kennesaw, GA (US)

Correspondence Address: David R. Irvin, IBM Corporation T81/503, P.O. Box 12195, Research Triangle Park, NC, 27709, US

(73) Assignee: International Business Machines Corporation, Armonk, NY

(21) Appl. No.: 09/932,163

(22) Filed: Aug. 17, 2001

(51) Int. Cl. G06F 17/28

(52) U.S. Cl. 704/2

(57) ABSTRACT

A personality type indicator is determined for a user who interacts with a server. The determination is made by analyzing information gathered by observing the user's interactions with the server rather than by asking the user to answer explicit questions. The content or the style of an information presentation is customized according to the user's personality type indicator. In one embodiment of the invention, the personality type indicator is a Myers Briggs Type Indicator.

### FIELD OF THE INVENTION

The present invention is related to the field of on-line information presentation, and more specifically to a method for customizing the content or style of a server's presentation of information to a user according to the user's personality type, in order to improve the user's comprehension and enjoyment of the presentation.

### BACKGROUND

With the advent and rapid growth of the Internet and the World Wide Web, the quantity of information that many people now encounter has brought the term “information overload” into the lexicon. As the quantity of information continues to grow, it becomes increasingly important to tailor the content of information to meet the needs of Internet users—the consumers of information—so that they are not overloaded, and to meet the desires of information providers so that their voices are heard by the intended audience.

Today, in the context of the Internet, a wide range of ad hoc techniques are used to combat information overload. Although many of these techniques provide some degree of advantage, each has its drawbacks. These drawbacks are especially evident in view of the rapid growth of the Internet, which has been accompanied by a wide variety of behavior patterns exhibited by Internet users. Because of this wide variety, an ad hoc approach to tailoring the presentation of information does not work well, as the information provider cannot today determine with any degree of certainty how to best tailor the information delivered to the user so that the likelihood of information overload is minimized.

Thus, given this limitations of today's ad hoc methods, there remains a need to tailor the content or style of information presented to a user in a systematic way that efficiently accommodates a wide variety of behaviors and situations, so that the user is not overloaded and the provider of the information is able to deliver an effective message.

### SUMMARY OF THE INVENTION

The present invention provides a way of customizing the content or style of information presented to a user by a server such as an Internet web site. In the course of interacting with the server, the user provides data to the server that implicitly reveals aspects of his personality. In the context of the present invention, the characterization “implicitly” means that the user does not need to complete a questionnaire of the type normally required to determine a personality type indicator. For example, rather than respond to an explicit question, the user may reveal something about his personality through the brevity or lengthiness of his postings to chatrooms, through his evident interests in particular hobbies, through the time he typically dwells on a web page before moving on, and so forth. Using such data, the server may categorize the user according to a personality type indicator that describes the user systematically and coherently rather than ad hoc. One embodiment of the invention categorizes users according to the well known Myers Briggs Type Indicator (MBTI). According to the user's MBTI or other personality type indicator, the content or style of information presented by the server is customized to suit the personality of the user.

Thus the present invention provides a way of customizing a presentation of information to a user by a server, so that the user is not overloaded by information delivered in an inappropriate way, so that the user may enjoy the presentation to the maximum extent possible, and so that the information provider who controls the server is able to deliver information effectively. These and other aspects of the present invention will become apparent to those skilled in the art after reading the following detailed description of the invention when considered together with the drawings.

### BRIEF DESCRIPTION OF THE DRAWINGS

FIG. 1, which is a block diagram, shows aspects of the structure of an exemplary embodiment of the invention.

FIG. 2, which is a flowchart, shows aspects of the operation of an exemplary embodiment of the invention.

### DETAILED DESCRIPTION

The present invention provides a way of customizing the content or style of information presented to a user, which takes into account the personality of the user. As the user interacts with a server of information, the user inherently provides data that implicitly reveals aspects of his personality. From this data, the server categorizes the user according to a personality type indicator, and customizes its presentation of information according to the personality type indicator associated with the user.

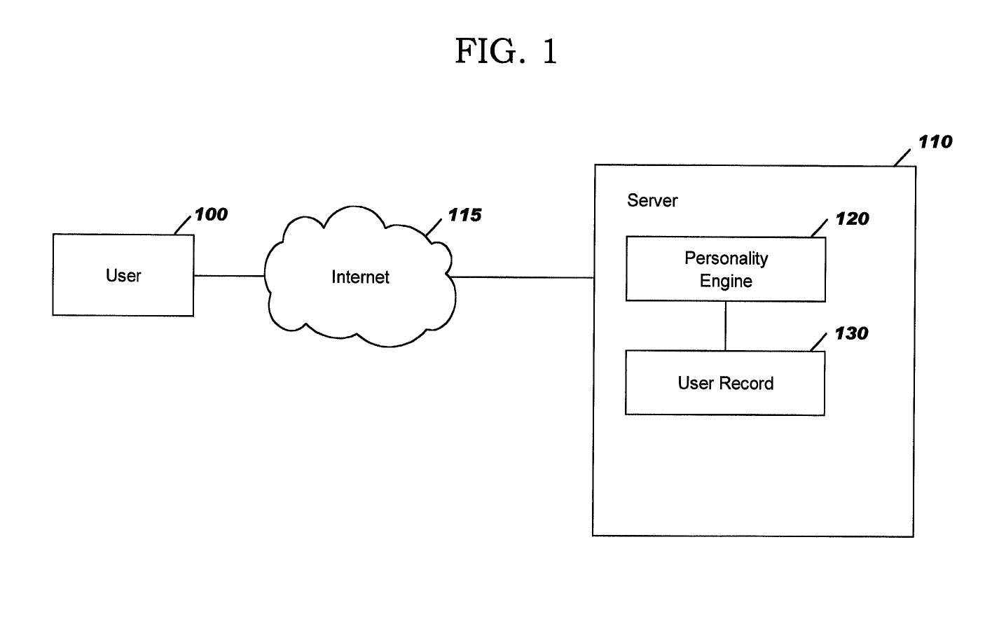

FIG. 1 shows aspects of the structure of an exemplary embodiment of the invention. In FIG. 1, a user 100 connects through the Internet 115 or other communication network, typically by way of a web browser, to a server 110 in order to access information provided by the server 110.

The server 110 includes a personality engine 120, which may be a stand-alone element, or which may be programmable instructions executed by a processor such as a microprocessor that may be used also to perform other functions of the server 110. The personality engine 120 categorizes the user 100 according to a personality type indicator as explained below.

The server 110 also includes a repository of information associated with the user 100, which repository is called here a “user record” 130. The user record 130 may be included within the personality engine 120, or may be separate and elsewhere in the server 110 or, in other embodiments, external to the server 110. Although FIG. 1 shows only a single user record 130, the server 110 may include more than one such user record, in order to accommodate more than one user. As explained further below, the user record 130 includes a personality type indicator associated with the user 100, and historical or other data useful in determining and applying the personality type indicator.

In accord with the personality type indicator held in the user record 130, the server 110 customizes the content or style of the information that it presents to the user 100. For example, if the personality type indicator had four values, the server 110 might customize the presentation of the information by selecting one of four versions of the presentation of the information, where the four versions differed in content or style. The server 110 may customize the presentation of the information on demand, or the various versions of the presentation may be prepared in advance and cached or otherwise stored by the server 110 for future use.

The personality type indicator may have N variables or dimensions or axes, where N is a positive integer. For example, the personality type indicator may be a function of binary variables or predetermined pairs, where the two values of a binary variable or the two elements of a pair may be thought of as inverses or opposites of each other. In the four-value example introduced above, the user 100 might be, hypothetically, honest (H) or deceitful (D), where honest-deceitful is the first binary variable, and kind (K) or cruel (C), where kind-cruel is the second binary variable. Thus the exemplary personality type indicator may take the values HK, i.e., honest and kind, or DC, i.e., deceitful and cruel, or HC, i.e., honest and cruel, or DK, i.e., deceitful and kind. In this example, the particular value of the personality type indicator (HK, DC, HC, or DK) associated with the user 100 would determine which of the four versions of the information would be selected for presentation to the user 100 by the server 110.

In a preferred embodiment of the invention, the personality engine 120 categorizes the user 100 according to a personality type indicator that is the well known Myers Briggs Type Indicator (MBTI). The MBTI is a function of four binary variables, which are extroversion-introversion (E, I), sensing-intuition (S, N), thinking-feeling (T, F), and judging-perceiving (J, P). Consequently, the MBTI takes on sixteen values: ESTP (i.e., an extroverted, sensing, thinking, perceiving personality), ESTJ, ISTJ, ISTP, ISFJ, ISFP, ESFP, ESFJ, INFJ, INFP, ENFP, ENFJ, INTJ, INTP, ENTP, and ENTJ.

For the user 100, appropriate values of the four MBTI variables may be deduced from data gathered and recorded by the personality engine 120 when the user 100 and the server 110 interact.

For example, the value of the extroversion-introversion variable may be deduced from the time that the user 100 typically spends on a web page before moving on (called here “topic dwelling time”), or from the brevity or lengthiness of chatroom postings by the user 100, or from knowledge of a hobby of the user 100. More specifically, an extrovert moves quickly from one web page to another, i.e., has a low average topic dwelling time, makes chatroom postings that are relatively short and directed to a relatively large number of recipients, and enjoys hobbies such as group games and team sports (and, consequently, may have purchased equipment related to the hobby in the past). Conversely, an introvert has a higher average topic dwelling time, makes chatroom postings that are relatively long and directed to relatively few recipients, and enjoys hobbies such as reading, gardening, and sewing.

Likewise, the value of the sensing-intuition variable may be deduced from, for example, linguistic analysis of the chatroom postings of the user 100. Chatroom postings of a user 100 who is characterized by sensing may be simple and to the point, using verbs in the past and present tenses; whereas chatroom postings of a user 100 who is characterized by intuition may often include compound sentences, frequently with repetition, recaps, and rephrasing, using verbs in the future tense.

Further, the value of the thinking-feeling variable may be deduced from, for example, sociological analysis of the chatroom postings of the user 100. A user who is characterized by thinking may seldom ask whether timing is convenient for another chatroom participant, may offer praise sparingly to others, may often neglect social niceties, and may use people's names infrequently; whereas a user who is characterized by feeling may often ask if timing is convenient for another, is often generous with praise, engages in social niceties, and uses people's names frequently.

The value of the judging-perceiving variable may be deduced from, for example, observation of a choice by the user 100 of an interface with the server 110. A user who is characterized by judging may choose an organized interface, whereas a user who is characterized by perceiving may choose an interface that is artistic, creative, and fun to use.

As a result of the richness of the MBTI, the present invention may be applied advantageously in situations where the server 110 provides information through a wide variety of applications such as discussion groups, chatrooms, search engine functions, on-line shopping, and so forth, all under a portal or an umbrella. Such situations provide is widely diverse data from which values of the variables of the personality type indicator may be deduced.

The personality engine 120 keeps logs of the occurrences of events that are implicitly relevant to deducing the values of the variables of the personality type indicator. When the personality type indicator is the MBTI, four pairs of logs are kept: (1) for the extroversion-introversion variable, a log for events indicative of an extroverted personality, and a companion log for events indicative of an introverted personality; (2) for the sensing-intuition variable, a log for events indicative of a sensing personality, and a companion log for events indicative of an intuiting personality; (3) for the thinking-feeling variable, a log for events indicative of a thinking personality, and a companion log for events indicative of a feeling personality; and (4) for the judging-preceiving variable, a log for events indicative of a judging personality, and a companion log for events indicative of a perceiving personality. For example, the logs may be counters.

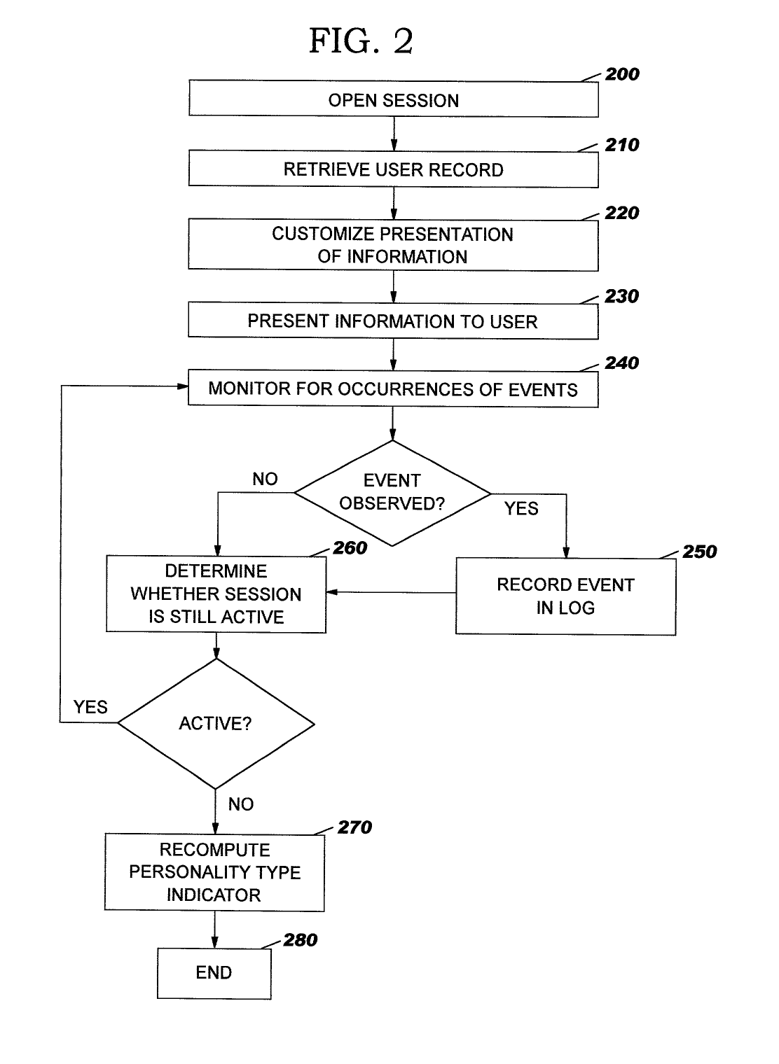

FIG. 2 shows aspects of the operation of an illustrative embodiment of the invention. The user 100 may start the process by opening a session with the server 110 (step 200), for example by accessing the server 110 and requesting information. The personality engine 120 retrieves the user record 130 associated with the user 100 (step 210), and the value of the personality type indicator held within the user record 130. According to the value of personality type indicator, the server 110 customizes (as explained further below) the content or style of the information that it presents to the user 100 (step 220). The server 110 then presents the information, customized, to the user 100 (step 230).

While the session is ongoing between the user 100 and the server 110, the personality engine 120 monitors for occurrences of the events that are implicitly relevant to deducing the values of the variables of the personality type indicator (step 240). When an event is observed, the personality engine 120 records the occurrence of the event in the appropriate log (step 250). For example, the log of the extroversion-introversion variable may be kept as follows: when the user 100 makes a chatroom posting that has a length of less than twenty words, a counter of events indicative of an extrovert personality may be incremented; conversely, when the user 110 makes a chatroom posting having twenty or more words, a counter of events indicative of an introvert personality may be incremented. Analogous methods hold for keeping the logs of the other variables of the personality type indicator. To ensure timeliness of the contents of the user record 130, entries may be discarded from the logs by using a sliding window algorithm, or by some other method, so that the oldest occurrences are removed as appropriate.

Otherwise (i.e., an event is not observed, which is the negative path following step 240 of FIG. 2), or upon recording the occurrence of an event (i.e., upon leaving step 250 of FIG. 2), the personality engine 130 or other logic within the server 110 determines whether the session between the user 100 and the server 110 is still active (step 260). If the session is active, the personality engine 130 continues to monitor for the occurrence of events that are implictly relevant to deducing the values of the variables of the personality type indicator (step 240).

Otherwise (i.e., the session has ended), the personality engine 120 retrieves the logs and recomputes the personality type indicator (step 270). In an exemplary embodiment of the invention, values of the variables of the personality type indicator may be deduced by testing the contents of the logs. For example, the value of a binary variable, such as the MBTI extroversion-introversion variable, may be determined by taking a majority vote of paired counters associated with the binary variable—e.g., if the MBTI extroversion log had ten entries and the introversion log three, the value of the extroversion-introversion variable for the user 100 would be deduced, by majority vote, to be E rather than I. Values of the other variables may be deduced in the same way, and the value of the personality type indicator computed from the values of its variables. The use of majority vote is illustrative of the present invention rather than limiting, of course, and once taught the present invention those skilled in the art will understand that a number of other algorithms may be employed to test the contents or otherwise analyze the logs in order to deduce the values of the variables of the personality type indicator.

Upon completion of the recomputation of the personality type indicator, the process ends (step 280).

As mentioned above, the presentation of information to the user 100 by the server 110 is customized according to the value of the personality type indicator associated with the user 100. The following exemplary customizations may be included in the aforementioned embodiment of the invention that employs the MBTI as the personality type indicator: When the MBTI indicates that the user 100 is an extrovert, the presentation may include a variety of topics, and provide enhanced opportunity for interaction such as opportunities to participate chatrooms or discussion groups; whereas when the MBTI indicates that the user 100 is an introvert, the presentation may focus on a single topic. When the MBTI indicates that the user 100 is sensing, the presentation may state its topic with special attention paid to clarity; whereas when the MBTI indicates that the user 100 is intuitive, the presentation may discuss the “big picture” and its implications. When the MBTI indicates that the user 100 is thinking, the presentation may focus on consequences, and use language associated with the thought process; whereas when the MBTI indicates that the user 100 is feeling, the presentation may affirm the legitimacy of feelings and use warm language associated with emotions. Finally, when the MBTI indicates that the user 100 is judging, the presentation may be especially clearly organized and efficient; whereas when the MBTI indicates that the user 100 is perceiving, the presentation may provide the user 100 with choices such as artistic interfaces that are fun to use.

From the foregoing description, those skilled in the art will appreciate that the present invention makes the on-line presentation of information more effective and more enjoyable by customizing the presentation to take into account the personality type of the consumer of the information. The foregoing description, however, is illustrative rather than limiting, and the scope of the present invention is limited only by the following claims.

We claim:

1. A method for suiting a presentation of information to the personality type of a user of the information, comprising the steps of:
logging occurrences of events that are implicitly relevant to deducing a value of a variable of a personality type indicator associated with the user;
deducing the value of the variable of the personality type indicator from the logged occurrences of events; and
customizing a presentation of information to the user according to the value of the variable of the personality type indicator.

2. The method of claim 1, wherein the presentation of information is delivered from a server to the user by Internet.

3. The method of claim 2, wherein the step of deducing is performed by the server.

4. A method for suiting a presentation of information to the personality type of a user of the information, comprising the steps of:
logging occurrences of events that are implicitly relevant to deducing values of variables of a Myers Briggs Type Indicator associated with the user;
deducing the values of the variables of the Myers Briggs Type Indicator from the logged occurrences of events;
computing a value of the Myers Briggs Type Indicator from the values of the variables; and
customizing a presentation of information to the user according to the Myers Briggs Type Indicator.

5. A method for suiting a presentation of information to the personality type of a user of the information, comprising the steps of:
deducing a value of an extroversion-introversion variable of a personality type indicator associated with a user from events that are implicitly relevant to deducing the value of the extroversion-introversion variable;
deducing a value of a sensing-intuition variable of the personality type indicator from events that are implicitly relevant to deducing the value of the sensing-intuition variable;
deducing a value of a thinking-feeling variable of the personality type indicator from events that are implicitly relevant to deducing the value of the thinking-feeling variable;
deducing a value of a judging-perceiving variable of the personality type indicator from events that are implicitly relevant to deducing the value of the judging-perceiving variable;
computing a value of a personality type indicator from the value of the extroversion-introversion variable, the value of the sensing-intuition variable, the value of the thinking-feeling variable, and the value of the judging-perceiving variable; and
customizing a presentation of information to the user according to the value of the personality type indicator.

6. The method of claim 5, wherein the value of the extroversion-introversion variable is deduced from topic dwelling time.

7. The method of claim 5, wherein the value of the extroversion-introversion variable is deduced from a hobby of the user.

8. The method of claim 5, wherein the value of the sensing-intuition variable is deduced from linguistic analysis of a chatroom posting.

9. The method of claim 5, wherein the value of the thinking-feeling variable is deduced from sociological analysis of a chatroom posting.

10. The method of claim 5, wherein the value of the judging-perceiving variable is deduced from a choice by the user of an interface with a server.
